(19) United States
(12) Patent Application Publication
(10) Pub. No.: US 2023/0342418 A1
(43) Pub. Date: Oct. 26, 2023

(54) Efficient Triangular Systolic Array-Based Matrix Inversion

(71) Applicant: Intel Corporation, Santa Clara, CA (US)

(72) Inventors: Tolga Ayhan, San Jose, CA (US); Mahshid Shahmohammadian, Campbell, CA (US); Kulwinder Singh Dhanoa, Southall (GB); Nima Safari, Uxbridge (GB)

(21) Appl. No.: 18/217,011

(22) Filed: Jun. 30, 2023

(51) Int. Cl. G06F 17/16

(52) U.S. Cl. CPC G06F 17/16

(57) ABSTRACT

Integrated circuit devices, methods, and circuitry for implementing and using a systolic array are provided. Such circuitry may include processing elements arranged in a triangular systolic array. The processing elements may receive an input matrix and perform Cholesky decomposition in a first stage, triangular matrix inversion in a second stage, and matrix multiplication in a third stage to produce an inverse of the input matrix as an output matrix.

### BACKGROUND

This disclosure relates to circuitry of an integrated circuit to perform matrix inversion using a triangular systolic array.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Many integrated circuits include arithmetic circuit blocks to perform arithmetic operations such as addition and multiplication. For example, a digital signal processing (DSP) block may supplement programmable logic circuitry in a programmable logic device, such as a field programmable gate array (FPGA). Programmable logic circuitry and DSP blocks may be used to perform numerous different arithmetic functions.

Many electronic devices also include radio systems to rapidly communicate data wireless to other electronic devices. Some radio systems, such as those that use multi-input and multiple-output (MIMO) techniques to take advantage of multipath propagation of radio signals, may employ large dimension matrix inversion for noise whitening and minimum mean square error (MMSE)-based beamforming. Moreover, some recent developments, such as the use of 7-2 split, specify that demodulation reference signals (DMRS) channel estimation and beamforming be performed at the location of an open radio unit (O-RU), placing stringent specifications on the computational complexity of the baseband processing. When this processing is performed by an FPGA, the total DSP, memory, and programmable logic circuitry resources consumed by the matrix inversion circuitry to satisfy the throughput and latency specifications of massive MIMO become very critical, especially for large dimensions.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device;

FIG. 2 is a block diagram of the integrated circuit device of FIG. 1;

FIG. 3 is a block diagram of an example of systolic array circuitry having two triangular systolic arrays that may be used to perform matrix operations on the integrated circuit device;

FIG. 4 is a block diagram of an example of systolic array circuitry having a single triangular systolic array that may be used to perform matrix operations on the integrated circuit device;

FIG. 5 is a block diagram of an example of systolic array circuitry having a single triangular systolic array and additional corresponding helper processing elements that may be used to perform matrix operations on the integrated circuit device;

FIG. 6 is a flowchart of a method for performing matrix inversion using the systolic array circuitry of FIG. 3, 4, or 5;

FIG. 7 is a block diagram of an arrangement of processing elements (PE) of the systolic array circuitry of FIG. 3;

FIG. 8 is a block diagram illustrating how processing elements (PEs) of opposite triangular systolic arrays of the systolic array circuitry may be used as helper PEs to increase processing throughput when not otherwise in use;

FIG. 9 is a flow diagram illustrating a manner of performing matrix inversion using the systolic array circuitry using two triangular systolic arrays that share diagonal processing elements (PEs);

FIG. 10 is a flowchart of a method for performing matrix inversion using the systolic array circuitry using two triangular systolic arrays that share diagonal processing elements (PEs);

FIG. 11 is a block diagram of a processing element (PE) of the systolic array circuitry;

FIG. 12 is a block diagram of selection circuitry to route data to and from a processing element (PE) when helper PEs are used;

FIG. 13 is a flow diagram illustrating a manner of performing matrix inversion using the systolic array circuitry using a single triangular systolic array;

FIG. 14 is a flowchart of a method for performing matrix inversion using the systolic array circuitry using a single triangular systolic array;

FIG. 15 is a block diagram of a processing element (PE) of the systolic array circuitry having multiple inputs corresponding to different matrix operations;

FIG. 16 is a flow diagram illustrating a manner of performing matrix inversion using the systolic array circuitry using a single triangular systolic array and corresponding helper processing elements (PEs);

FIG. 17 is a flowchart of a method for performing matrix inversion using the systolic array circuitry using a single triangular systolic array and corresponding helper processing elements (PEs);

FIG. 18 is a block diagram of selection circuitry to route data to and from a processing element (PE) when the PE has multiple inputs and outputs and when helper PEs are used;

FIG. 19 is a timing diagram illustrating the timing of processing stages corresponding to Cholesky decomposition, triangular matrix inversion, and matrix multiplication using the systolic array circuitry; and

FIG. 20 is a block diagram of a data processing system that may include an integrated circuit that implements systolic array circuitry to perform matrix operations.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

There are many different approaches to matrix inversion. One of these approaches is a direct implementation based on Cholesky decomposition, followed by triangular matrix inversion using forward substitution, and triangular matrix multiplication. Systolic arrays may be used to perform these operations. Indeed, systolic arrays may be employed for applications involving high concurrency and balance between computation and memory access. Systolic arrays may use regular structures known as processing elements (PEs) and coordinating the data flow between them. Because Cholesky decomposition, triangular matrix inversion, and triangular matrix multiplication may use barely more than half of an N×N systolic array at any one point in time, the idle PEs may instead operate as helper PEs that share resources with active PEs or the idle PEs may be eliminated entirely. This may increase the throughput of the systolic array in the case of using helper PEs or reduce a total area consumed by the systolic array in the case of eliminating the otherwise idle PEs.

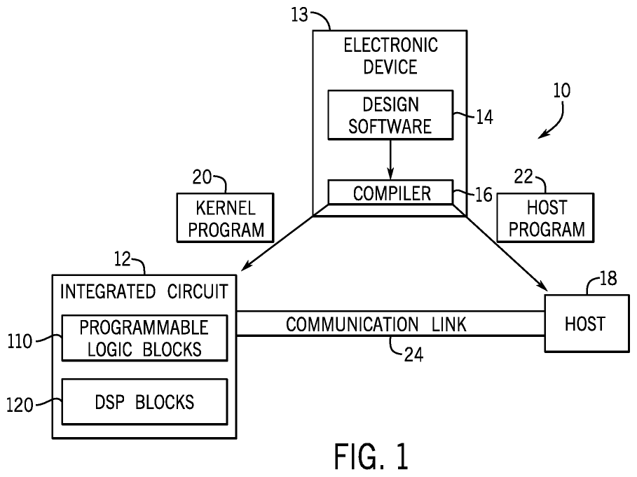

FIG. 1 illustrates a block diagram of a system 10 that may be used to implement the systolic array of this disclosure on an integrated circuit system 12 (e.g., a single monolithic integrated circuit or a multi-die system of integrated circuits). A designer may desire to implement iterative modular multiplication on the integrated circuit system 12 (e.g., a programmable logic device such as a field-programmable gate array (FPGA) or an application-specific integrated circuit (ASIC) that includes programmable logic circuitry). The integrated circuit system 12 may include a single integrated circuit, multiple integrated circuits in a package, or multiple integrated circuits in multiple packages communicating remotely (e.g., via wires or traces). In some cases, the designer may specify a high-level program to be implemented, such as an OPENCL® program that may enable the designer to more efficiently and easily provide programming instructions to configure a set of programmable logic cells for the integrated circuit system 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit system 12.

In a configuration mode of the integrated circuit system 12, a designer may use an electronic device 13 (e.g., a computer) to implement high-level designs (e.g., a system user design) using design software 14, such as a version of INTEL® QUARTUS® by INTEL CORPORATION. The electronic device 13 may use the design software 14 and a compiler 16 to convert the high-level program into a lower-level description (e.g., a configuration program, a bitstream). The compiler 16 may provide machine-readable instructions representative of the high-level program to a host 18 and the integrated circuit system 12. The host 18 may receive a host program 22 that may control or be implemented by the kernel programs 20. To implement the host program 22, the host 18 may communicate instructions from the host program 22 to the integrated circuit system 12 via a communications link 24 that may include, for example, direct memory access (DMA) communications or peripheral component interconnect express (PCIe) communications. In some embodiments, the kernel programs 20 and the host 18 may configure programmable logic blocks 110 on the integrated circuit system 12. The programmable logic blocks 110 may include circuitry and/or other logic elements and may be configurable to implement a variety of functions in combination with digital signal processing (DSP) blocks 120.

The designer may use the design software 14 to generate and/or to specify a low-level program, such as the low-level hardware description languages described above. Further, in some embodiments, the system 10 may be implemented without a separate host program 22. Thus, embodiments described herein are intended to be illustrative and not limiting.

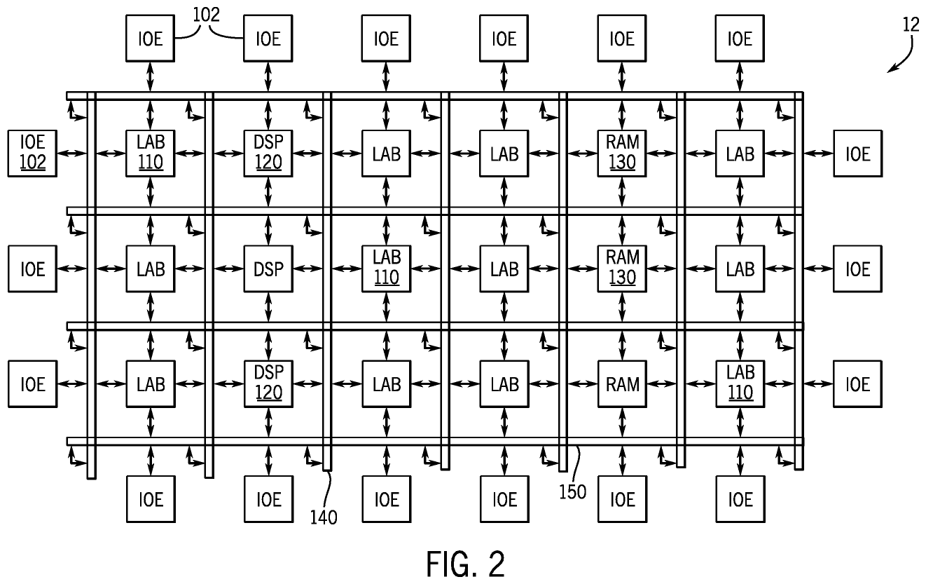

An illustrative embodiment of a programmable integrated circuit system 12 such as a programmable logic device (PLD) that may be configured to implement a circuit design is shown in FIG. 2. The PLD shown in FIG. 2 may represent programmable logic of any suitable device (e.g., an Intel® Agilex® FPGA, an Intel® Stratix® FPGA). As shown in FIG. 2, the integrated circuit system 12 (e.g., a field-programmable gate array integrated circuit) may include a two-dimensional array of functional blocks, including programmable logic blocks 110 (also referred to as logic array blocks (LABs) or configurable logic blocks (CLBs)) and other functional blocks, such as embedded digital signal processing (DSP) blocks 120 and embedded random-access memory (RAM) blocks 130, for example. Functional blocks such as LABs 110 may include smaller programmable regions (e.g., logic elements, configurable logic blocks, or adaptive logic modules) that receive input signals and perform custom functions on the input signals to produce output signals. LABs 110 may also be grouped into larger programmable regions sometimes referred to as logic sectors that are individually managed and configured by corresponding logic sector managers. The grouping of the programmable logic resources on the integrated circuit system 12 into logic sectors, logic array blocks, logic elements, or adaptive logic modules is merely illustrative. In general, the integrated circuit system 12 may include functional logic blocks of any suitable size and type, which may be organized in accordance with any suitable logic resource hierarchy.

Programmable logic of the integrated circuit system 12 may include programmable memory elements. Memory elements may be loaded with configuration data (also called programming data or configuration bitstream) using input-output elements (IOEs) 102. Once loaded, the memory elements provide a corresponding static control signal that controls the operation of an associated functional block (e.g., LABs 110, DSP 120, RAM 130, or input-output elements 102).

In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory, configuration random-access memory (CRAM), or programmable memory elements. The integrated circuit system 12 may undergo configuration or partial reconfiguration to implement a custom circuit design. For example, the configuration RAM may be programmed such that LABs 110, DSP 120, and RAM 130, programmable interconnect circuitry (e.g., vertical channels 140 and horizontal channels 150), and the input-output elements 102 form the circuit design implementation.

In addition, the programmable logic device may have input-output elements (IOEs) 102 for driving signals off the integrated circuit system 12 and for receiving signals from other devices. Input-output elements 102 may include parallel input-output circuitry, serial data transceiver circuitry, differential receiver and transmitter circuitry, or other circuitry used to connect one integrated circuit to another integrated circuit.

The integrated circuit system 12 may also include programmable interconnect circuitry in the form of vertical routing channels 140 (e.g., interconnects formed along a vertical axis of the integrated circuit system 12) and horizontal routing channels 150 (e.g., interconnects formed along a horizontal axis of the integrated circuit system 12), each routing channel including at least one track to route at least one wire. The interconnect circuitry may include pipeline elements, and the contents stored in these pipeline elements may be accessed during operation. For example, a programming circuit may provide read and write access to a pipeline element.

Note that other routing topologies, besides the topology of the interconnect circuitry depicted in FIG. 1, are intended to be included within the scope of the disclosure. For example, the routing topology may include wires that travel diagonally or that travel horizontally and vertically along different parts of their extent as well as wires that are perpendicular to the device plane in the case of three-dimensional integrated circuits, and the driver of a wire may be located at a different point than one end of a wire. The routing topology may include global wires that span substantially all of the integrated circuit system 12, fractional global wires such as wires that span part of the integrated circuit system 12, staggered wires of a particular length, smaller local wires, or any other suitable interconnection resource arrangement. The integrated circuit system 12 may be programmed to perform a wide variety of operations, including the matrix operations of this disclosure.

### Systolic Array Approaches to Perform Matrix Inversion

As mentioned above, matrix inversion is used in a variety of systems. In massive MIMO systems, matrix inversion is used for noise whitening and MMSE-based beamforming. There have been many different approaches to matrix inversion. One of these approaches is based on Cholesky decomposition, followed by triangular matrix inversion using forward substitution, and triangular matrix multiplication. While some past techniques have involved using intermediate storage between the stages, the systems and methods of this disclosure may employ a multiplexer network that avoids this constraint. Instead, data output from one stage may be routed directly into the next stage.

A systolic array structure having an array of processing elements (PEs) may be used to achieve rapid and efficient matrix processing. The systolic array structure may employ an N×N systolic array or a triangular systolic array. The systems and methods of this disclosure may be implemented a device that includes programmable logic circuitry, such as field programmable gate array (FPGA) circuitry such as the LABs 110, DSPs 120, RAMs 130, or input-output elements 102 as discussed above. Additionally or alternatively, the systems and methods of this disclosure may be implemented using a hardened device such as an application-specific integrated circuit (ASIC) (e.g., a structured ASIC). Systolic arrays may be employed for applications involving high concurrency, balance between computation and memory access, using regular processing element (PE) structures and coordinating the data flow between them.

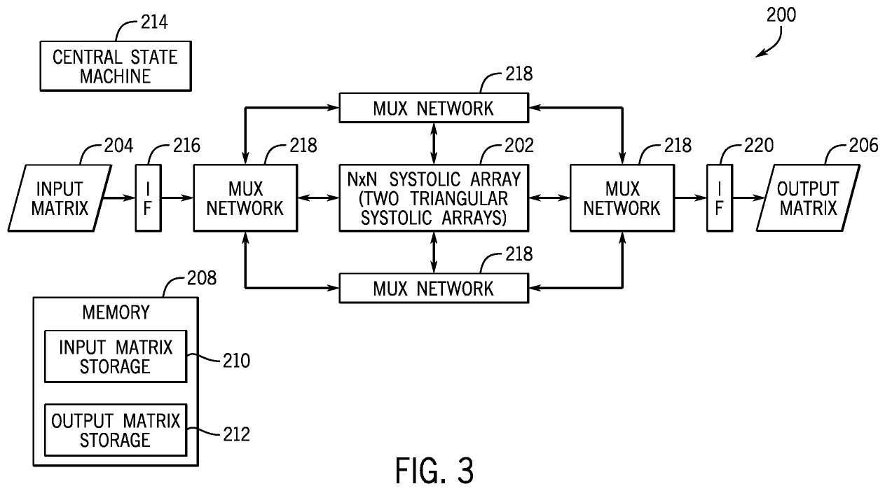

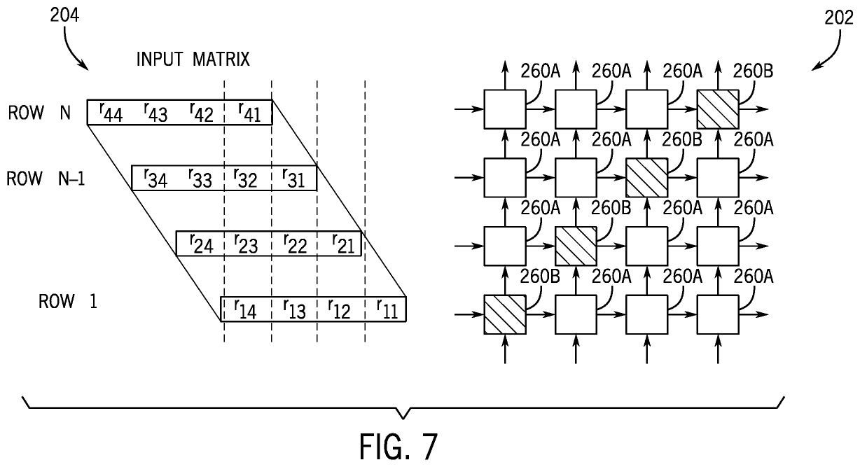

FIG. 3 represents a block diagram of a systolic array system 200 that uses an N×N systolic array 202, which may be considered two triangular systolic arrays of processing elements (PEs) sharing PEs along a diagonal axis (e.g., as shown in FIGS. 7, 8, and 9), to efficiently process an input matrix 204 to generate an output matrix 206. For example, the input matrix 204 may be a matrix of N rows and N columns (e.g., an N×N matrix) and the output matrix 206 may be the inverse of the input matrix 204. As discussed further below, the N×N systolic array 202 may take advantage of idle processing elements (PEs) to increase throughput and/or reduce latency. Any suitable memory 208 may be used to store the input matrix 204 (e.g., in input matrix storage 210) and the output matrix 206 (e.g., in output matrix storage 212). The memory 208 may be memory stored on the integrated circuit system 12 (e.g., based on RAM 130) or off-die (e.g., double-data rate random access memory (DDR RAM), high-bandwidth memory (HBM)).

A central state machine 214 may route the input matrix 204 through a memory interface 216 into multiplexer networks 218 for processing in the N×N systolic array 202 and output through a memory interface 220. As the N×N systolic array 202 processes the data through various stages (e.g., Cholesky decomposition, triangular matrix inversion, and triangular matrix multiplication), the multiplexer networks 218 may directly feed outputs from one stage back into the N×N systolic array 202 for processing in the next stage. This may reduce the number of memory writes and reads, as well as reduce the amount memory storage space used, by avoiding storing intermediate data between the stages in the memory 208. The central state machine 214 may be any suitable state machine circuitry to control the feeding of the input matrix 204 through the memory interface 216 and through the multiplexer networks 218. The central state machine 214 may control the multiplexer networks 218 to route output data to and from the N×N systolic array 202 between processing stages and through the memory interface 220 after processing is complete.

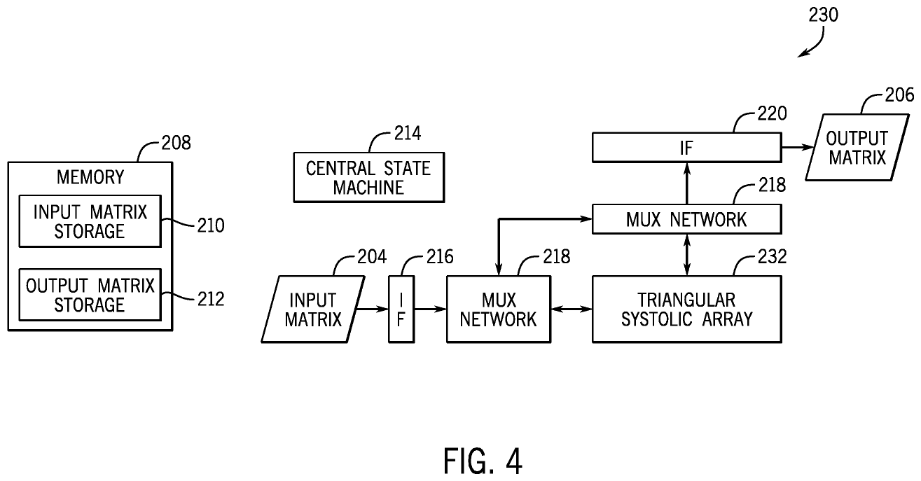

While FIG. 3 illustrates the systolic array system 200 that uses the N×N systolic array 202 (e.g., two triangular systolic arrays), FIG. 4 illustrates a systolic array system 230 that uses a single triangular systolic array 232. The single triangular systolic array 232 may perform the same computations as the N×N systolic array 202, but may use fewer resources (e.g., fewer LABs 110, fewer DSPs 120, fewer RAMs 130, less die area). Moreover, the multiplexer networks 218 may be comparatively smaller since only two surfaces of the triangular systolic array 232 may provide input into and output from the systolic array 232.

As with the systolic array system 200 of FIG. 3, the systolic array system 230 of FIG. 4 may employ any suitable memory 208 to store the input matrix 204 (e.g., in input matrix storage 210) and the output matrix 206 (e.g., in output matrix storage 212). The memory 208 may be memory stored on the integrated circuit system 12 (e.g., based on RAM 130) or off-die (e.g., double-data rate random access memory (DDR RAM), high-bandwidth memory (HBM)). The central state machine 214 of the systolic array system 230 may route the input matrix 204 through the memory interface 216 into the multiplexer networks 218 for processing in the triangular systolic array 232 and output through the memory interface 220. As the triangular systolic array 232 processes the data through various stages (e.g., Cholesky decomposition, triangular matrix inversion, and triangular matrix multiplication), the multiplexer networks 218 may directly feed outputs from one stage back into the triangular systolic array 232 for processing in the next stage. This may reduce the number of memory writes and reads, as well as reduce the amount memory storage space used, by avoiding storing intermediate data between the stages in the memory 208. The central state machine 214 may be any suitable state machine circuitry to control the feeding of the input matrix 204 through the memory interface 216 and through the multiplexer networks 218. The central state machine 214 may control the multiplexer networks 218 to route output data to and from the triangular systolic array 232 between processing stages and through the memory interface 220 after processing is complete.

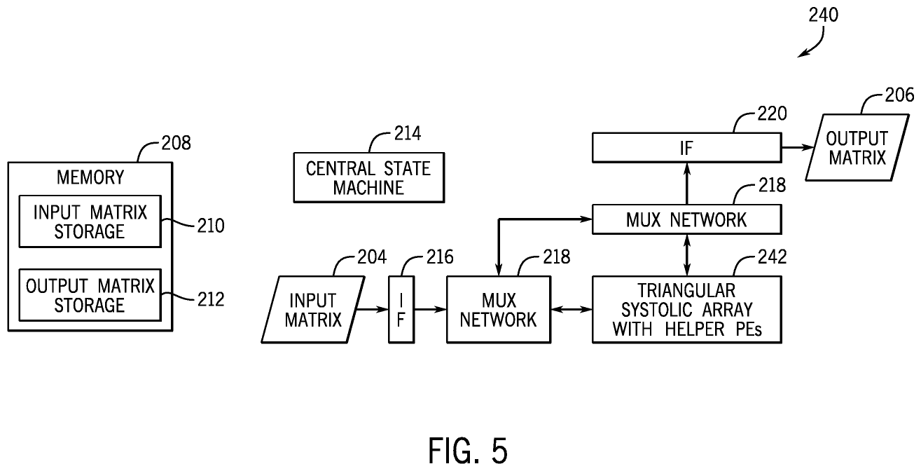

FIG. 5 illustrates a systolic array system 240 that uses a triangular systolic array with helper processing elements 242. The triangular systolic array with helper processing elements 242 may perform the same computations as the N×N systolic array 202 or the single triangular systolic array 232, but the multiplexer networks 218 may be comparatively smaller since only two surfaces of the triangular systolic array 232 may provide input into and output from the systolic array 232.

As with the systolic array system 200 of FIG. 3 and the systolic array system 230 of FIG. 4, the systolic array system 240 of FIG. 5 may employ any suitable memory 208 to store the input matrix 204 (e.g., in input matrix storage 210) and the output matrix 206 (e.g., in output matrix storage 212). The memory 208 may be memory stored on the integrated circuit system 12 (e.g., based on RAM 130) or off-die (e.g., double-data rate random access memory (DDR RAM), high-bandwidth memory (HBM)). The central state machine 214 of the systolic array system 230 may route the input matrix 204 through the memory interface 216 into the multiplexer networks 218 for processing in the triangular systolic array with helper processing elements 242 and output through the memory interface 220. As the triangular systolic array with helper processing elements 242 processes the data through various stages (e.g., Cholesky decomposition, triangular matrix inversion, and triangular matrix multiplication), the multiplexer networks 218 may directly feed outputs from one stage back into the triangular systolic array with helper processing elements 242 for processing in the next stage. This may reduce the number of memory writes and reads, as well as reduce the amount memory storage space used, by avoiding storing intermediate data between the stages in the memory 208. The central state machine 214 may be any suitable state machine circuitry to control the feeding of the input matrix 204 through the memory interface 216 and through the multiplexer networks 218. The central state machine 214 may control the multiplexer networks 218 to route output data to and from the triangular systolic array with helper processing elements 242 between processing stages and through the memory interface 220 after processing is complete.

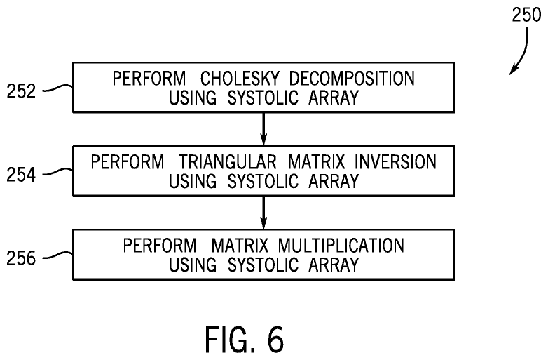

For all three examples of FIGS. 3, 4, and 5, matrix operations may be performed on the input matrix 204 to obtain an inverse matrix as the output matrix 206. One example of doing so is shown by a flowchart 250 of FIG. 6. Initially, data from the input matrix 204 may be routed into the systolic array 202, 232, or 242 and Cholesky decomposition may be performed (block 252). Thereafter, the resulting output data may be routed back into the systolic array 202, 232, or 242 and triangular matrix inversion may be performed (block 254). The complex conjugate of the resulting output data may be routed back into the systolic array 202, 232, or 242 and matrix multiplication may be performed (block 256) to produce an inverse matrix as the output matrix 206. Because the intermediate outputs between the stages may be routed back into the systolic array 202, 232, or 242, writing the intermediate outputs to memory and reading the intermediate outputs from memory may be avoided.

FIG. 7 provides one example of the arrangement of processing elements 260 that may be form the N×N systolic array 202, as well as the manner in which data from the input matrix 204 may be fed into the processing elements 260 of the N×N systolic array 202. The N×N systolic array 202 is formed by two types of processing elements 260: non-diagonal processing elements (PEs) 260A and diagonal processing elements (PEs) 260B. The diagonal PEs 260B perform a square root operation during Cholesky decomposition, which takes multiple clock cycles, in addition to the inversion and multiplication operations. The non-diagonal PEs 260A perform multiplication and/or division operations. The outputs from the array (e.g., Cholesky decomposition and triangular matrix inversion outputs) are fed back to the array during Cholesky decomposition and triangular matrix inversion phases, respectively, for the generation of the final inverted matrix entries.

Data may be fed into the PEs 260, starting with feeding data from Row 1, Column 1 (r₁₁) of the input matrix 204 at a first time into the lower-left diagonal PE 260B. Once the lower-left diagonal PE 260B has finished processing the data, it may pass on the resulting output to another PE 260 (e.g., the non-diagonal PE 260A directly above it in the systolic array 202). Subsequent data may be fed into the systolic array 202. For example, the lower-left diagonal PE 260B may receive data from Row 1, Column 2 (r₁₂) of the input matrix 204 and the non-diagonal PE 260A directly above it in the systolic array 202 may receive data from Row 2, Column 1 (r₂₁) of the input matrix 204 for further processing in combination with the data that was received from the lower-left diagonal PE 260B. Data processing may continue in this way as the input matrix 204 is fed into the systolic array 202 and as the data propagates through the systolic array 202.

The systolic array 202 may process multiple channels of data, effectively allowing multiple independent matrices to be inverted in the same procedure. For example, the data from Row 1, Column 1 (r₁₁¹) of a first input matrix 204 may be fed into the systolic array at a first clock cycle, data from Row 1, Column 1 (r₁₁²) of a second input matrix 204 may be fed into the systolic array at a second clock cycle, data from Row 1, Column 1 (r₁₁³) of a third input matrix 204 may be fed into the systolic array at a third clock cycle, and so on as desired. As will be discussed further below, the diagonal PEs 260B perform an operation that has a greater latency than operations performed by the non-diagonal PEs 260A. As such, multi-channel operation may be employed to mask the latency of this operation. For example, new input matrices may be fed into the systolic array every 3*N*K clock cycles, where N is the dimension of the square input matrix, and K is the latency per “step” of the operation (here, a “step” is defined as the time interval from the clock cycle a PE has valid input to the clock cycle it produces the corresponding output). K is, in general, limited by the latency of the square root operation. Multi-channel operation is employed to mask the latency of this operation (so that the non-diagonal PEs 260A, which perform a multiplication task, are utilized during a square root computation performed by the diagonal PEs 260B). The number of channels M may be equal to K=2*M, where M is the number of channels (e.g., the number of independent matrices to be inverted in parallel).

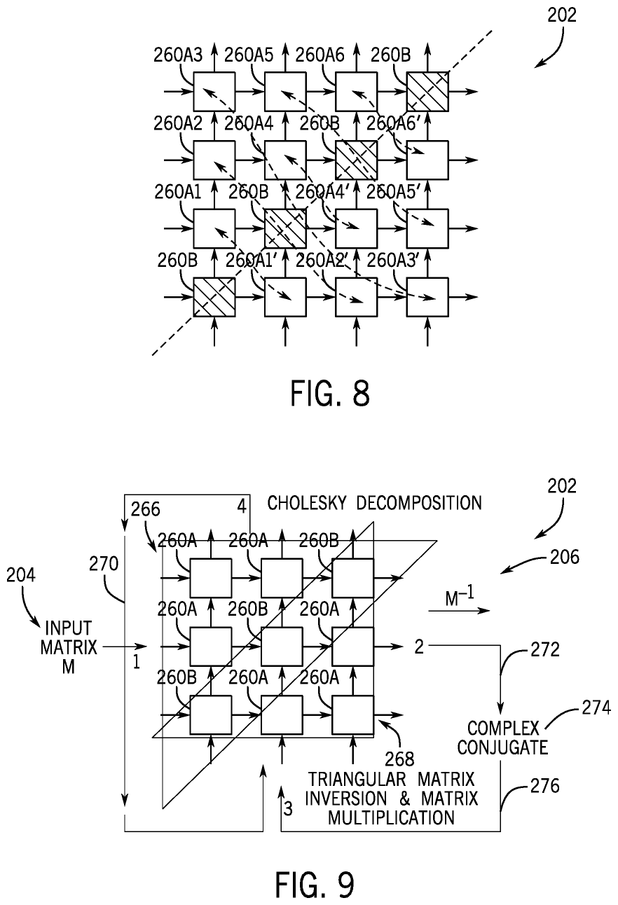

To increase efficiency, non-diagonal processing elements (PEs) 260A may be paired with “helper” PEs 260A that would otherwise be idle. In a simplified example of an N×N systolic array 202 having N=4, shown in FIG. 8, non-diagonal PEs 260A1, 260A2, 260A3, 260A4, 260A5, and 260A6 may be paired with corresponding helper non-diagonal PEs 260A1′, 260A2′, 260A3′, 260A4′, 260A5′, and 260A6′, respectively. Corresponding PE pairs of non-diagonal PEs 260A and helper PEs 260A′ may share resources (e.g., local memory) and may process data from previous PEs 260 in a time-multiplexed manner, thereby increasing the throughput of the N×N systolic array 202.

One manner of performing matrix inversion using the systolic array 202 is shown in FIG. 9. In the example of FIG. 9, Cholesky decomposition may take place using a first triangular systolic array 266 formed from an upper-left portion of the N×N systolic array 202, whereas triangular matrix inversion and matrix multiplication may take place in a second triangular systolic array 268 formed from a lower-right portion of the N×N systolic array 202. When one triangular systolic array is in use (e.g., the first triangular systolic array 266 for Cholesky decomposition, the second triangular systolic array 268 for triangular matrix inversion or matrix multiplication), the non-diagonal PEs 260A of the other triangular systolic array (e.g., the non-diagonal PEs 260A of the second triangular systolic array 268 during Cholesky decomposition, the non-diagonal PEs 260A of the first triangular systolic array 266 during triangular matrix inversion or matrix multiplication) may be used as “helper PEs” to assist with the operations.

The Cholesky decomposition stage (e.g., block 252 of FIG. 6) may start when the input matrix 204 is fed into the first triangular systolic array 266 of the systolic array 202. The diagonal PEs 260B of the N×N systolic array 202 may perform a square root operation and the non-diagonal PEs 260A of the first triangular systolic array 266 may perform a multiplication operation. Cholesky decomposition aims to decompose a Hermitian, positive definite matrix into the product of a lower triangular matrix (denoted by L below) and its conjugate transpose L^{H} which is the upper triangular matrix as R=L·L^{H}.

The diagonal elements of L (denoted by uⱼⱼ) are given by the following equation:

$${u}_{jj} = \sqrt{{R}_{jj} - {{\sum }^{j - 1}}_{k = 1} {u}_{j k} * {u}_{j k}^{*}}$$

The non-diagonal elements of L are given by the following equation:

$${u}_{ij} = \frac{( {R}_{i j} - {\sum }_{k = 1}^{j - 1} {u}_{i k} * {u}_{j k}^{*} )}{{u}_{jj}} , i > j$$

The non-diagonal PEs 260A of the second triangular systolic array 268 may act as “helper PEs” during the Cholesky decomposition stage.

The triangular matrix inversion stage (e.g., block 254 of FIG. 6) starts as soon as the first Cholesky decomposition output exits the N×N systolic array 202 at the top row (interface 4) and is fed back into the array through the interface 3 (e.g., via a data pathway 270 formed through a multiplexer network) of the same column. The operation continues until the entire second triangular systolic array 268 is filled with vij values (i.e., all values of triangular matrix inversion have been computed). During the triangular matrix inversion stage, values of the diagonal elements and non-diagonal elements may be given according to the following equations:

$$\begin{matrix}{v}_{ii} = 1 / {u}_{ii} \\ {v}_{ji} = 1 / {u}_{ii} * {\sum }_{k = j}^{i - 1} {u}_{i k} {v}_{k j} i \neq j\end{matrix}$$

The non-diagonal PEs 260A of the first triangular systolic array 266 may act as “helper PEs” during the triangular matrix inversion stage.

In the matrix multiplication stage (e.g., block 256 of FIG. 6), the complex conjugate of result of the triangular matrix inversion stage may be multiplied against stored values from the triangular matrix inversion stage. As the triangular matrix inversion elements are computed, they are stored in local memory of the respective PEs 260 and sent out via interface 2 for the matrix multiplication phase. When these elements exit the array at the last column of the array, they are fed back through the interface 3 of the array (e.g., via a data pathway 272 formed through the multiplexer network). The data pathway 272 continues through a data pathway 274 that routes the data to produce a complex conjugate of the output elements, which are then provided via a data pathway 276 formed through the multiplexer network back into the second triangular systolic array 268. The resulting output matrix 206 may be stored in the memory upon completion. The non-diagonal PEs 260A of the first triangular systolic array 266 may act as “helper PEs” during the matrix multiplication stage.

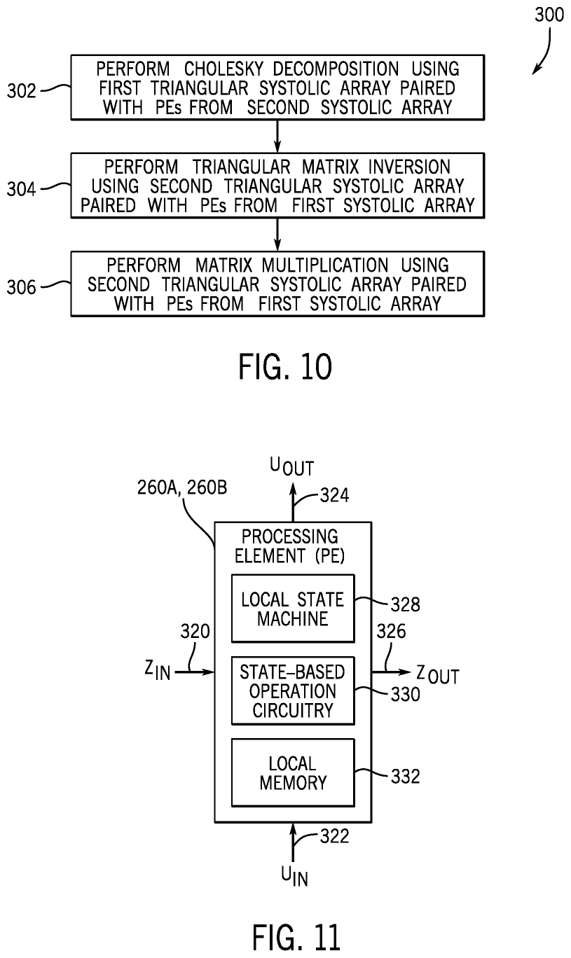

To summarize, as shown by a flowchart 300 of FIG. 10, data from the input matrix 204 may be routed into the first triangular systolic array 266 and Cholesky decomposition may be performed using the first triangular systolic array 266 with non-diagonal PEs 260A of the second triangular systolic array 268 acting as “helper PEs” (block 302). The resulting output data may be routed into the second triangular systolic array 268 and triangular matrix inversion may be performed using the second triangular systolic array 268 with non-diagonal PEs 260A of the first triangular systolic array 266 acting as “helper PEs” (block 304). The complex conjugate of the resulting output data may be routed back into the second triangular systolic array 268 and matrix multiplication may be performed using the second triangular systolic array 268 with non-diagonal PEs 260A of the first triangular systolic array 266 acting as “helper PEs” (block 306) to produce an inverse matrix as the output matrix 206.

Processing elements (PEs) 260 may take any suitable form. For example, as shown in FIG. 11, the processing elements 260 may include at least input/output interfaces 320 (Zin), 322 (Uin), 324 (Uout), and 326 (Zout), local state machine circuitry 328, state-based operation circuitry 330, and local memory 332. Whereas a centralized state machine (e.g., the centralized state machine 214 of FIG. 3) may control the routing (e.g., multiplexer control) of outputs and inputs at the systolic array boundaries for transitions between the stages of operation and the final output memory interface, the local state machine circuitry 328 controls the state-based operation circuitry 330 (e.g., by controlling multiplexers to choose the operation to be performed) based on the current state and the valid samples coming from the input interfaces (e.g., input ports) of the PE 260. The non-diagonal PEs 260A may have different state machine circuitry 328 or state-based operation circuitry 330 to cause the PE 260A or 260B to perform the appropriate operation (e.g., square root, matrix multiplication).

With half precision values (16 bits), the input or output matrix storage of an N×N matrix takes N2*2*2 Bytes of storage per channel. The local memory 332 may store 3N2*2*2 Bytes of memory per channel to store the Cholesky decomposition and triangular matrix inversion output values for each PE 260, as well as the temporary storage of inputs until they get processed. As such, when the PE 260 is implemented in a PLD such as described in FIG. 2, the usage of distributed memory (e.g., the RAM 130 of FIG. 2, MLABs) for local storage is advantageous since every PE 260 benefits from access to small amount of memory (read and write operations) simultaneously.

When implemented in a PLD such as described in FIG. 2, each PE 260 may consume one DSP for half precision processing, which can perform one of the following operations via the state-based operation circuitry 330:
(a) Square root: The diagonal PEs 260B perform this operation at specific states. The half precision floating point inverse square root block may use one multiplier and, in some examples, 139 LUTs, with a latency of 7 clock cycles. The design may be pipelined, meaning that it can accept a new input every clock cycle for the multi-channel operation.
(b) Complex multiplication: There may be a total of four half precision floating point multiplications and two additions, which can be done in two clock cycles using one DSP.
(c) Division by real number (multiplication with 1/uᵢᵢ): Since a complex number is multiplied with a real number, this operation may take one cycle using two half-precision multipliers.

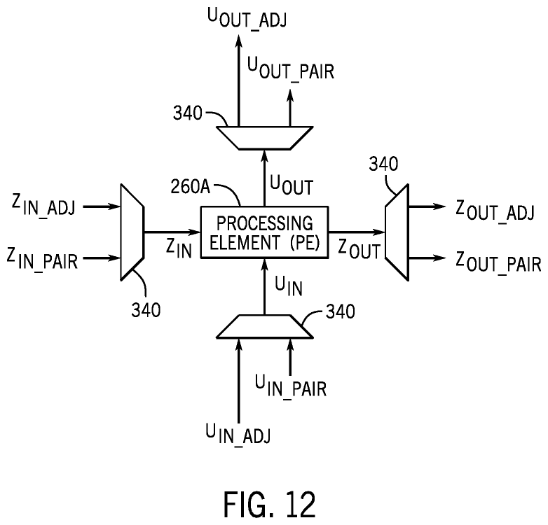

Pairs of PEs 260 may operate on data in a time-multiplexed manner. For example, as shown in FIG. 12, non-diagonal PEs 260A may include input/output (I/O) multiplexers 340 to select between inputs provided from a previous adjacent PE or from the corresponding helper PE of that adjacent PE (e.g., I_{n_adj} or I_{in_pair}, U_{in_adj} or U_{in_pair}). The I/O multiplexers 340 may select between outputs to provide to a next adjacent PE or from the corresponding helper PE of that adjacent PE (e.g., Z_{out_adj} or Z_{out_pair}, U_{out_adj} or U_{out_pair}) The multiplexers 340 may be controlled by the local state machine 328 the PE 260A or by a central state machine for the systolic array (e.g., the central state machine 214 of FIG. 3). Time multiplexing may be applied to share data between the non-diagonal PE 260A and its corresponding helper PE. For example, at one clock cycle, data may be received from a prior adjacent PE (e.g., Z_{in_adj} or U_{in_adj}), while at another clock cycle (e.g., the next clock cycle), data may be received from the helper PE of the prior adjacent PE (e.g., Z_{in_pair} or U_{in_pair}). Likewise, data output by the PE 260A may be output to a next adjacent PE (e.g., Z_{out_adj} or U_{out_adj}) at one clock cycle, while at another clock cycle (e.g., the next clock cycle), data may be provided to the helper PE of the next adjacent PE (e.g., Z_{out_pair} or U_{out_pair}). Moreover, in some embodiments, a PE 260A and its corresponding helper PE may share the same local memory 328. Using PEs 260A that would otherwise be idle to assist with matrix operations may significantly increase the throughput of the N×N systolic array 202.

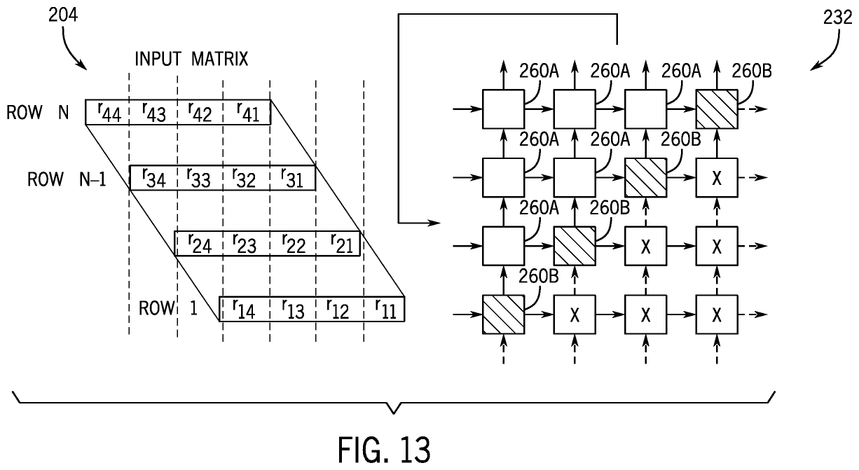

FIG. 13 illustrates another way of improving the efficiency of matrix operations by removing the non-diagonal PEs 260A of the lower-right part of the N×N systolic array to obtain the triangular systolic array 232 (e.g., as discussed above with reference to FIG. 4). The input matrix 204 may enter the triangular systolic array 232 from an interface on one side (e.g., the leftmost side) and exit from another side (e.g., the topmost side) for each operation. As with the N×N systolic array 202, the triangular systolic array 232 may be fed multiple channels of input matrices 204 to mask the latency of the diagonal PEs 260B while they the diagonal PEs 260B perform a square root operation, which may take multiple clock cycles (e.g., 4 clock cycles, 6 clock cycles, 8 clock cycles, 10 clock cycles, 12 clock cycles).

The systolic array 232 may process multiple channels of data, effectively allowing multiple independent matrices to be inverted in the same procedure. For example, the data from Row 1, Column 1 (r₁₁¹) of a first input matrix 204 may be fed into the systolic array at a first clock cycle, data from Row 1, Column 1 (r₁₁²) of a second input matrix 204 may be fed into the systolic array at a second clock cycle, data from Row 1, Column 1 (r₁₁³) of a third input matrix 204 may be fed into the systolic array at a third clock cycle, and so on as desired. As mentioned above, the diagonal PEs 260B perform an operation that has a greater latency than operations performed by the non-diagonal PEs 260A. As such, multi-channel operation may be employed to mask the latency of this operation. For example, new input matrices may be fed into the systolic array every 3*N*K clock cycles, where N is the dimension of the square input matrix, and K is the latency per “step” of the operation (here, a “step” is defined as the time interval from the clock cycle a PE has valid input to the clock cycle it produces the corresponding output). K is, in general, limited by the latency of the square root operation. Multi-channel operation is employed to mask the latency of this operation (so that the non-diagonal PEs 260A, which perform a multiplication task, are utilized during a square root computation performed by the diagonal PEs 260B). The number of channels M may be equal to K=2*M, where M is the number of channels (e.g., the number of independent matrices to be inverted in parallel).

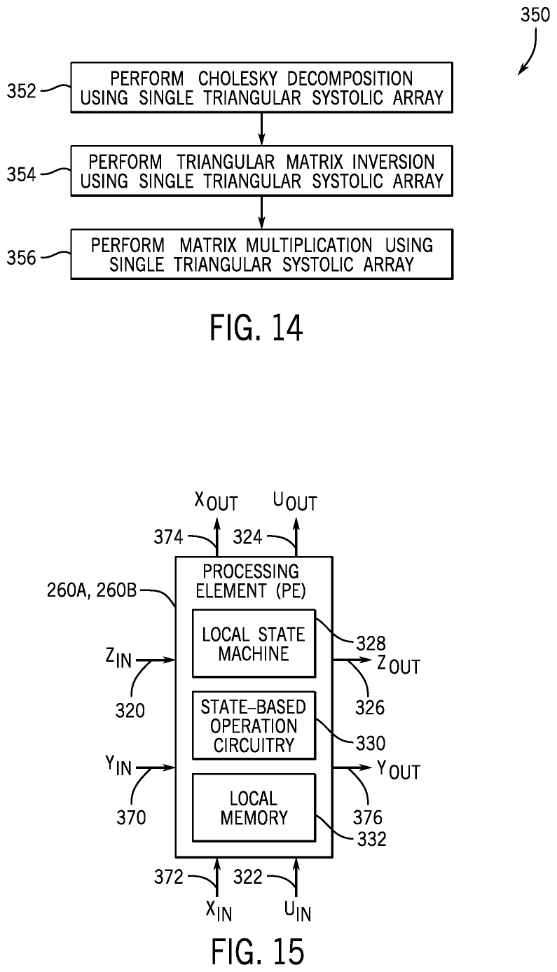

As shown by a flowchart 350 of FIG. 14, data from the input matrix 204 may be routed into the triangular systolic array 232 and Cholesky decomposition may be performed (block 352). The resulting output data may be routed back into the triangular systolic array 232 and triangular matrix inversion may be performed (block 354). The complex conjugate of the resulting output data may be routed back into the triangular systolic array 232 and matrix multiplication may be performed (block 356) to produce an inverse matrix as the output matrix 206.

Since all of the PEs 260 of the triangular systolic array 232 may perform Cholesky decomposition, triangular matrix inversion, and matrix multiplication, the local state machine circuitry 328 of the PEs 260 may either track the state of the triangular systolic array 232 to control which operations are to be performed at any point in any suitable way. For example, as shown in FIG. 15, the local state machine circuitry 328 may track the state based on receiving data from specific input interfaces, also sometimes referred to as input ports or I/Os. Additionally or alternatively, the local state machine circuitry 328 may track the state based on other measures, such as the number of clock cycles since data has been initially input, upon receipt of specific initialization data representing an initialization command, upon receipt of a specific reset signal (e.g., from the central state machine), or the like.

In the example of FIG. 15, the PEs 260 may include the input/output interfaces 320 (Zin), 322 (Uin), 324 (Uout), and 326 (Zout), as well as input/output interfaces 370 (Yin), 372 (Xin), 374 (Xout), and 376 (Yout). The local state machine circuitry 328 may control the state-based operation circuitry 330 and the local memory 332 to perform different operations based on the receipt of data on a particular input/output interface 320, 322, 370, or 372. For example, when data is received over the input/output interfaces 320 or 322, the local state machine circuitry 328 may control the state-based operation circuitry 330 and the local memory 332 to perform Cholesky decomposition and output the results on the input/output interfaces 324 or 326. When data is received over the input/output interfaces 370 or 372, the local state machine circuitry 328 may control the state-based operation circuitry 330 and the local memory 332 to perform triangular matrix inversion or matrix multiplication and output the results on the input/output interfaces 374 or 376. The PEs 260 of FIG. 15 may otherwise operate like the PEs 260 of FIG. 11 to perform matrix operations.

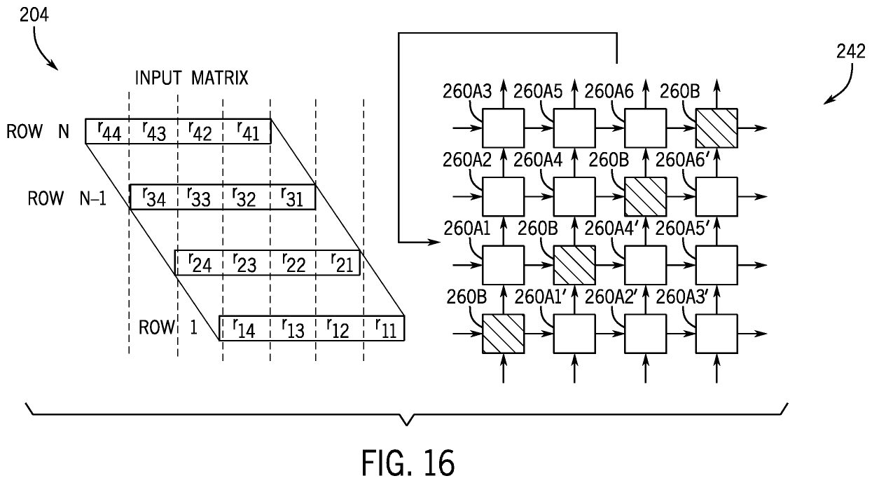

While the triangular systolic array 232 may take up less die area and use fewer resources (e.g., fewer programmable logic elements, DSPs, memory), helper PEs may be included in the triangular systolic array with helper PEs 242 to increase throughput. Indeed, the triangular systolic array with helper PEs 242 may be represented as an N×N systolic array in which output data between stages is routed back to the same triangular systolic array, rather than to a different triangular systolic array as in the system of FIG. 3. In FIG. 16, to increase efficiency, non-diagonal processing elements (PEs) 260A may be paired with “helper” PEs 260A. In a simplified example of the triangular systolic array with helper PEs 242 having N=4, shown in FIG. 16, non-diagonal PEs 260A1, 260A2, 260A3, 260A4, 260A5, and 260A6 may be paired with corresponding helper non-diagonal PEs 260A1′, 260A2′, 260A3′, 260A4′, 260A5′, and 260A6′, respectively. Corresponding PE pairs of non-diagonal PEs 260A and helper PEs 260A′ may share resources (e.g., local memory) and may process data from previous PEs 260 in a time-multiplexed manner, thereby increasing the throughput of the triangular systolic array with helper PEs 242 compared to the triangular systolic array 232.

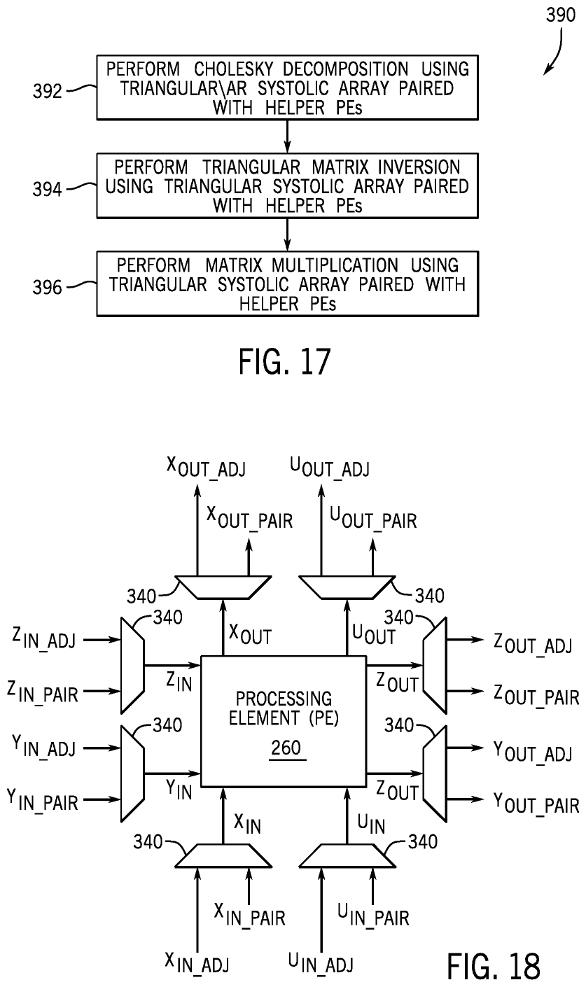

As shown by a flowchart 390 of FIG. 17, data from the input matrix 204 may be routed into the triangular systolic array with helper PEs 242 and Cholesky decomposition may be performed using the triangular systolic array paired with helper PEs (block 392). The resulting output data may be routed back into the triangular systolic array with helper PEs 242 and triangular matrix inversion may be performed using the triangular systolic array paired with helper PEs (block 394). The complex conjugate of the resulting output data may be routed back into the triangular systolic array with helper PEs 242 and matrix multiplication may be performed using the triangular systolic array paired with helper PEs (block 396) to produce an inverse matrix as the output matrix 206.

Pairs of PEs 260 of the triangular systolic array with helper PEs 242 may operate on data in a time-multiplexed manner. For example, as shown in FIG. 18, non-diagonal PEs 260A may include several input/output (110) multiplexers 340 to select between inputs provided from a previous adjacent PE or from the corresponding helper PE of that adjacent PE (e.g., Z_{in_adj} or Z_{in_pair}, U_{in_adj} or U_{in_pair}, Y_{in_adj} or Yin pair, X_{in_adj} or X_{in_pair}). The 110 multiplexers 340 may select between outputs to provide to a next adjacent PE or from the corresponding helper PE of that adjacent PE (e.g., Z_{out_adj} or Z_{out_pair}, U_{out_adj} or U_{out_pair}, Y_{out_adj} or Y_{out_pair}, X_{out_adj} or X_{out_pair}). The multiplexers 340 may be controlled by the local state machine 328 the PE 260A or by a central state machine for the systolic array (e.g., the central state machine 214 of FIG. 5). Time multiplexing may be applied to share data between the non-diagonal PE 260A and its corresponding helper PE. For example, at one clock cycle, data may be received from a prior adjacent PE (e.g., X_{in_adj}, Y_{in_adj}, Z_{in_adj}, or U_{in_adj}), while at another clock cycle (e.g., the next clock cycle), data may be received from the helper PE of the prior adjacent PE (e.g., X_{in_pair}, Y_{in_pair}, Z_{in_pair}, or U_{in_pair}). Likewise, data output by the PE 260A may be output to a next adjacent PE (e.g., X_{out_adj}, Y_{out_adj}, Z_{out_adj}, or U_{out_adj}) at one clock cycle, while at another clock cycle (e.g., the next clock cycle), data may be provided to the helper PE of the next adjacent PE (e.g., X_{out_pair}, Y_{out_pair}, Z_{out_pair}, or U_{out_pair}). Moreover, in some embodiments, a PE 260A and its corresponding helper PE may share the same local memory 328.

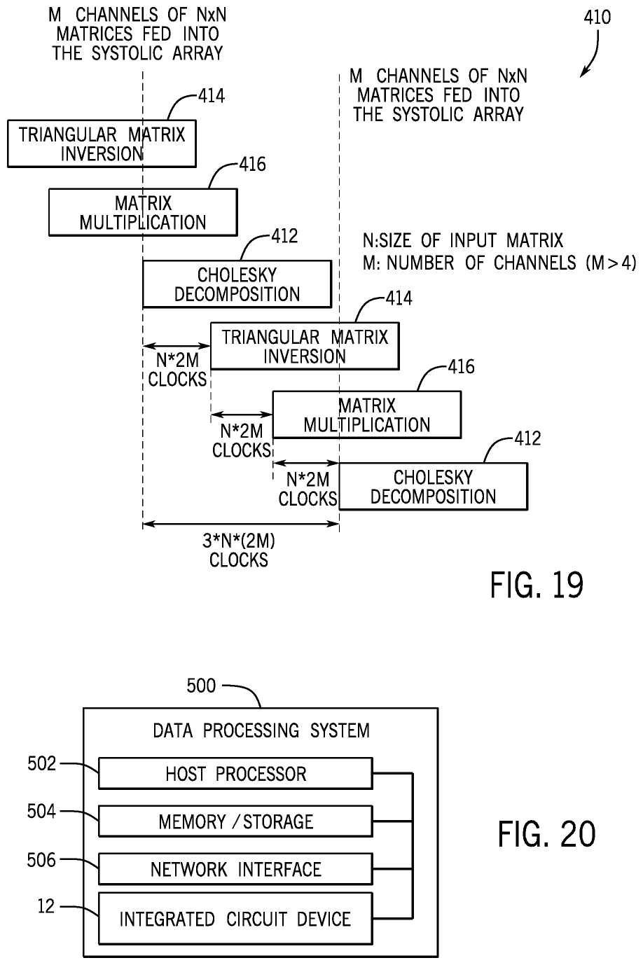

FIG. 19 is a timing diagram 410 illustrating the use of the triangular systolic array 232 to perform Cholesky decomposition (blocks 412), triangular matrix inversion (blocks 414), and matrix multiplication (blocks 416) repeatedly. Each time Cholesky decomposition (block 412) begins, M channels of N×N input matrices may be fed into the triangular systolic array 232, where N is the size of the input matrix and M is the number of channels (e.g., M is at least 2, at least 4, at least 6, at least 8). Triangular matrix inversion (block 414) may begin N*2M clock cycles later, matrix multiplication (block 416) may begin N*2M clock cycles after that, and finally Cholesky decomposition (block 412) may begin again after another N*2M clock cycles. Thus, the triangular systolic array 232 may perform all three stages over a total of 3*N*2M clock cycles.

The circuitry discussed above may be implemented on the integrated circuit system 12 as hardened circuitry (e.g., circuitry that is not configurable or reconfigurable) or as circuitry programmed in programmable logic (e.g., soft circuitry configurable or reconfigurable on an FPGA). Moreover, the integrated circuit system 12 may be a component included in a data processing system, such as a data processing system 500, shown in FIG. 20. The data processing system 500 may include the integrated circuit system 12 (e.g., an ASIC, a programmable logic device), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 20 may include the integrated circuit system 12 with the programmable routing bridge 84. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the integrated circuit system 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a personal device or a commercial device that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks. The network interface 506 may interface with a MIMO wireless system. Thus, the data processing system 500 may receive data via the MIMO wireless system, which may benefit from the matrix inversion circuitry of this disclosure due to its low latency and high throughput, enabling the data processing system 500 to perform noise whitening and minimum mean square error (MMSE)-based beamforming or other data processing for wireless networking. When this processing is performed by an FPGA, the total DSP, memory, and programmable logic circuitry resources consumed by the matrix inversion circuitry to satisfy the throughput and latency specifications of massive MIMO may be efficiently used by the systolic array circuits of this disclosure.

The techniques and methods described herein may be applied with other types of integrated circuit systems. For example, the programmable routing bridge described herein may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

### Example Embodiment 1

Circuitry comprising:
a plurality of processing elements arranged in a triangular systolic array, wherein the plurality of processing elements receive an input matrix and perform Cholesky decomposition in a first stage, triangular matrix inversion in a second stage, and matrix multiplication in a third stage to produce an inverse of the input matrix as an output matrix.

### Example Embodiment 2

The circuitry of example embodiment 1, wherein the plurality of processing elements respectively comprise state machine circuitry to control when to perform operations corresponding to the first stage, the second stage, and the third stage.

### Example Embodiment 3

The circuitry of example embodiment 1, wherein the plurality of processing elements respectively comprise a first input interface used in the first stage and a second input interface used in the second stage and the third stage.

### Example Embodiment 4

The circuitry of example embodiment 3, wherein the plurality of processing elements respectively comprise state machine circuitry, wherein the respective state machine circuitry of the plurality of processing elements controls the respective processing element to perform an operation associated with Cholesky decomposition when data is received on the first input interface and perform an operation associated with triangular matrix inversion or matrix multiplication when data is received on the second input interface.

### Example Embodiment 5

The circuitry of example embodiment 1, comprising a multiplexer network controllable to route data output by the triangular systolic array in the first stage into the triangular systolic array for the second stage and route data output by the triangular systolic array in the second stage into the triangular systolic array for the third stage.

### Example Embodiment 6

The circuitry of example embodiment 5, wherein the multiplexer network is controllable to route the data output by the triangular systolic array in the second stage as a complex conjugate into the triangular systolic array for the third stage.

### Example Embodiment 7

The circuitry of example embodiment 5, comprising a central state machine to control the multiplexer network.

### Example Embodiment 8

The circuitry of example embodiment 1, wherein the triangular systolic array is implemented using circuitry of a programmable logic device.

### Example Embodiment 9

The circuitry of example embodiment 8, wherein respective processing elements are implemented using circuitry of the programmable logic device that comprises a digital signal processing (DSP) block circuit that can perform at least four half precision floating point multiplications and two additions in two clock cycles.

### Example Embodiment 10

The circuitry of example embodiment 9, wherein respective processing elements are implemented using circuitry comprising exactly one digital signal processing (DSP) block per processing element.

### Example Embodiment 11

The circuitry of example embodiment 1, wherein the triangular systolic array is implemented using hardened circuitry of an application-specific integrated circuit (ASIC).

### Example Embodiment 12

An article of manufacture comprising tangible, non-transitory, machine-readable media comprising data to configure programmable logic circuitry of an integrated circuit to implement:
a triangular systolic array to receive an input matrix and perform Cholesky decomposition in a first stage, triangular matrix inversion in a second stage, and matrix multiplication in a third stage to produce an inverse of the input matrix as an output matrix;
a multiplexer network to route data to and from the triangular systolic array between stages; and
a central state machine to control the multiplexer network.

### Example Embodiment 13

The article of manufacture of example embodiment 12, wherein the triangular systolic array is to receive multiple channels of input matrices.

### Example Embodiment 14

The article of manufacture of example embodiment 12, wherein the triangular systolic array comprises a plurality of helper processing elements to operate in parallel with other processing elements of the triangular systolic array.

### Example Embodiment 15

The article of manufacture of example embodiment 12, wherein the triangular systolic array comprises a plurality of input interfaces corresponding to different stages.

### Example Embodiment 16

The article of manufacture of example embodiment 12, wherein the plurality of input interfaces comprises a first input interface corresponding to the first stage and a second input interface corresponding to the second stage, wherein a state of the triangular systolic array is based at least in part on whether data is received via the first input interface or the second input interface.

### Example Embodiment 17

A method comprising:
providing an input matrix to a systolic array of processing elements;
performing Cholesky decomposition on the input matrix comprising using a first set of the processing elements paired with a second set of the processing elements to obtain a first intermediate output;
providing the first intermediate output to the systolic array without writing the first intermediate output to memory;
performing triangular matrix inversion on the first intermediate output using the first set of the processing elements paired with the second set of the processing elements to obtain a second intermediate output;
providing a complex conjugate of the second intermediate output to the systolic array without writing the first intermediate output to memory; and
performing matrix multiplication of the second intermediate output and the complex conjugate of the second intermediate output using the first set of the processing elements paired with the second set of the processing elements to obtain an inverse matrix of the input matrix.

### Example Embodiment 18

The method of example embodiment 17, wherein providing the input matrix comprises providing a plurality of channels of independent input matrices.

### Example Embodiment 19

The method of example embodiment 17, wherein the first set of the processing elements is time multiplexed with the second set of the processing elements.

### Example Embodiment 20

The method of example embodiment 17, wherein the second intermediate output is locally stored as well as output by the systolic array to enable matrix multiplication of the second intermediate output and the complex conjugate of the second intermediate output.

What is claimed is:

1. Circuitry comprising:
a plurality of processing elements arranged in a triangular systolic array, wherein the plurality of processing elements receive an input matrix and perform Cholesky decomposition in a first stage, triangular matrix inversion in a second stage, and matrix multiplication in a third stage to produce an inverse of the input matrix as an output matrix.

2. The circuitry of claim 1, wherein the plurality of processing elements respectively comprise state machine circuitry to control when to perform operations corresponding to the first stage, the second stage, and the third stage.

3. The circuitry of claim 1, wherein the plurality of processing elements respectively comprise a first input interface used in the first stage and a second input interface used in the second stage and the third stage.

4. The circuitry of claim 3, wherein the plurality of processing elements respectively comprise state machine circuitry, wherein the respective state machine circuitry of the plurality of processing elements controls the respective processing element to perform an operation associated with Cholesky decomposition when data is received on the first input interface and perform an operation associated with triangular matrix inversion or matrix multiplication when data is received on the second input interface.

5. The circuitry of claim 1, comprising a multiplexer network controllable to route data output by the triangular systolic array in the first stage into the triangular systolic array for the second stage and route data output by the triangular systolic array in the second stage into the triangular systolic array for the third stage.

6. The circuitry of claim 5, wherein the multiplexer network is controllable to route the data output by the triangular systolic array in the second stage as a complex conjugate into the triangular systolic array for the third stage.

7. The circuitry of claim 5, comprising a central state machine to control the multiplexer network.

8. The circuitry of claim 1, wherein the triangular systolic array is implemented using circuitry of a programmable logic device.

9. The circuitry of claim 8, wherein respective processing elements are implemented using circuitry of the programmable logic device that comprises a digital signal processing (DSP) block circuit that can perform at least four half precision floating point multiplications and two additions in two clock cycles.

10. The circuitry of claim 9, wherein respective processing elements are implemented using circuitry comprising exactly one digital signal processing (DSP) block per processing element.

11. The circuitry of claim 1, wherein the triangular systolic array is implemented using hardened circuitry of an application-specific integrated circuit (ASIC).

12. An article of manufacture comprising tangible, non-transitory, machine-readable media comprising data to configure programmable logic circuitry of an integrated circuit to implement:
a triangular systolic array to receive an input matrix and perform Cholesky decomposition in a first stage, triangular matrix inversion in a second stage, and matrix multiplication in a third stage to produce an inverse of the input matrix as an output matrix;
a multiplexer network to route data to and from the triangular systolic array between stages; and
a central state machine to control the multiplexer network.

13. The article of manufacture of claim 12, wherein the triangular systolic array is to receive multiple channels of input matrices.

14. The article of manufacture of claim 12, wherein the triangular systolic array comprises a plurality of helper processing elements to operate in parallel with other processing elements of the triangular systolic array.

15. The article of manufacture of claim 12, wherein the triangular systolic array comprises a plurality of input interfaces corresponding to different stages.

16. The article of manufacture of claim 15, wherein the plurality of input interfaces comprises a first input interface corresponding to the first stage and a second input interface corresponding to the second stage, wherein a state of the triangular systolic array is based at least in part on whether data is received via the first input interface or the second input interface.

17. A method comprising:
providing an input matrix to a systolic array of processing elements;
performing Cholesky decomposition on the input matrix comprising using a first set of the processing elements paired with a second set of the processing elements to obtain a first intermediate output at a higher throughput than using only the first set of the processing elements;
providing the first intermediate output to the systolic array without writing the first intermediate output to memory;
performing triangular matrix inversion on the first intermediate output using the first set of the processing elements paired with the second set of the processing elements to obtain a second intermediate output at a higher throughput than using only the first set of the processing elements;
providing a complex conjugate of the second intermediate output to the systolic array without writing the first intermediate output to memory; and
performing matrix multiplication of the second intermediate output and the complex conjugate of the second intermediate output using the first set of the processing elements paired with the second set of the processing elements to obtain an inverse matrix of the input matrix at a higher throughput than using only the first set of the processing elements.

18. The method of claim 17, wherein providing the input matrix comprises providing a plurality of channels of independent input matrices.

19. The method of claim 17, wherein the first set of the processing elements is time multiplexed with the second set of the processing elements.

20. The method of claim 17, wherein the second intermediate output is locally stored as well as output by the systolic array to enable matrix multiplication of the second intermediate output and the complex conjugate of the second intermediate output to obtain the inverse matrix.
